(19) United States
(12) Patent Application Publication
(10) Pub. No.: US 2022/0165073 A1
(43) Pub. Date: May 26, 2022

(54) STATE DETECTION DEVICE AND STATE DETECTION METHOD

(71) Applicant: Panasonic Intellectual Property Management Co., Ltd., Osaka (JP)

(72) Inventors: Shinichi SHIKII, Nara (JP); Mika SUNAGAWA, Osaka (JP)

(21) Appl. No.: 17/432,450

(22) PCT Filed: Feb. 13, 2020
(86) PCT No.: PCT/JP2020/005426

§ 371 Date: Aug. 19, 2021

Related U.S. Application Data
(60) Provisional application No. 62/809,108, filed on Feb. 22, 2019.

(51) Int. Cl. G06V 20/59; G06V 20/56; G06V 20/58; B60W 40/09

(52) U.S. Cl. CPC G06V 20/597; G06V 20/588; B60W 2040/0818; B60W 40/09; G06V 20/58

(57) ABSTRACT

A state detection device (100) detects a state of a driver driving an automobile (300), and includes: a first camera (110) that captures a face of the driver at a first frame rate; a. second camera. (120) that captures an environment in a forward direction of the automobile at a second frame rate;

and a. processor (130) that processes images obtained from the first and second cameras (110, 120). The processor (130) calculates a :line-of-sight direction of both. eyes of the driver based on a face image obtained from. the first camera (110) and calculates a focal position of the driver based on the hue-of-sight direction. of both. eyes of the driver, and detects the state of the driver by determining the state of the driver based on the focal position and a forward image obtained from the second camera (120). The first frame rate is N times the second frame rate (N is an integer of 1 or greater),

### TECHNICAL FIELD

The present disclosure relates to a state detection device and a state detection method for detecting the state of a driver driving an automobile.

### BACKGROUND ART

Techniques have been proposed for detecting the state of a driver driving an automobile. Some of such techniques involve detecting (determining) the driver's state based on the driver's pupil diameter calculated from a face image obtained by a camera capturing the driver's face during driving (see Non Patent Literature (NPL) 1, for example).

### CITATION LIST

### Non Patent Literature

NPL 1: Masahiro Miyaji, et al., “Study on Effect of Adding Pupil Diameter as Recognition Features for Driver's Cognitive Distraction Detection”, IEEE, CSNDSP 2010, Nets4Cars-7, pp, 406-411.

### SUMMARY OF THE INVENTION

### Technical Problem

The pupil diameter, however, depends on the ambient brightness. This prevents the stable measurement, of the pupil diameter of the driver driving the automobile. Consequently, conventional techniques fail to accurately measure the driver's state.

The present disclosure provides a state detection device and the like that enable accurately detecting (measuring) the driver's state.

### Solutions to Problem

A state detection device according to an aspect of the present disclosure is a state detection device that detects a state of a driver driving an automobile, and includes: a first camera that captures a face of the driver at a first frame rate; a second camera that captures an environment in. a forward direction of the automobile at a second. frame rate; and a processor that: calculates a line-of-sight direction of both eyes of the driver based on a face image obtained from the first camera, and calculates a focal position of the driver based on the line-of-sight direction of the both eyes of the driver calculated; and detects the state of the driver by determining the state of the driver based on the focal position calculated and a forward image obtained from the second camera, wherein the first frame rate is N times the second frame rate, where N is an integer greater than or equal to 1.

Moreover, a state detection method according to an aspect of the present disclosure is a state detection method of detecting a state of a driver driving an automobile, and includes: capturing, by a first camera, a face of the driver at a first frame rate; capturing, by a second camera, an environment in a. forward direction of the automobile at a second frame rate; calculating a line-of-sight direction of both eyes of the driver based on. a face image obtained. from the first camera; calculating a focal position of the driver based on the line-of-sight direction. of the both. eyes of the driver calculated; and detecting the state of the driver by determining the state of the driver based on the focal position calculated and a forward image obtained from the second camera, wherein the first frame rate is N times the second frame rate.

Note that these general or specific aspects may be implemented using a system, a. method, an integrated circuit, a computer program, or a. computer-readable recording medium such as a CD-ROM, or any combination of systems, methods, integrated circuits, computer programs, or recording media.

### Advantageous Effect of Invention

The state detection device according to an aspect of the present disclosure enables accurately detecting a driver's state.

### BRIEF DESCRIPTION OF DRAWINGS

FIG. 1 is a block diagram illustrating a configuration of a state detection device according to an embodiment.

FIG. 2 is a diagram for describing a driver's focal position.

FIG. 3 is a flowchart showing process steps performed by the state detection device according to the embodiment.

### DESCRIPTION OF EXEMPLARY EMBODIMENT

### (Overview of Disclosure)

In order to solve the above problem, a state detection device according to an aspect of the present disclosure is a state detection device that detects a state of a driver driving an. automobile, and includes: a first camera that captures a face of the driver at a first frame rate; a second camera that captures an environment in a forward direction of the automobile at a second frame rate; and a processor that: calculates a line-of-sight direction of both eyes of the driver based on a face image obtained from the first camera, and calculates a focal position of the driver based on the line-of-sight direction of the both eyes of the driver calculated; and detects the state of the driver by determining the state of the driver based on the focal position calculated and a forward image obtained from the second camera, wherein the first frame rate is N times the second frame rate, where N is an integer greater than or equal to 1,

As above, the processor can detect the driver's state without using any parameter that depends on an external environment, such as the pupil diameter. The state detection device according to the present disclosure thus enables accurately detecting the driver's state. Because the first frame rate is N times the second frame rate, the processor can select the face image associated with the forward image in a simple manner. This reduces the processing load on the processor.

Moreover, for example, the first camera and the second camera are affixed to the automobile as an integral unit.

This prevents changes in the relative positional relationship between the first camera and the second camera. The driver's state can thus be detected more accurately.

Moreover, for example, the second camera is a time-of-flight (TOF) camera.

This enables accurately measuring how far the focal position of the driver's line of sight deviates from, for example, an object located in the line-of-sight direction. The driver's state can thus be detected more accurately.

Moreover, for example, the processor: calculates a position of an object located in the line-of-sight direction and in a vicinity of the automobile, based on the line-of-sight direction and. the forward. image; and determines the state of the driver based on the position of the object and. the focal position calculated.

Moreover, for example, the processor: determines that the state of the driver is normal when a distance between the position of the object and the focal position calculated is less than a predetermined distance; and determines that the state of the driver is not normal when the distance is greater than or equal to the predetermined distance.

As above, whether the driver is in a normal state can be accurately detected based on the distance between the position of the object and the focal position.

Moreover, for example, the processor determines that the state of the driver is not normal when an angle between the line-of-sight direction and the forward direction is greater than or equal to a predetermined angle.

If, for example, the driver's line-of-sight direction significantly deviates from the forward direction, this suggests that the driver is not driving normally, and consequently that the driver is not in a normal state. As such, the processor can appropriately determine that the driver is not in a normal state if the angle between the driver's line-of-sight direction and the forward direction is greater than or equal to the predetermined angle.

Moreover, for example, the state of the driver is an inattentive state of the driver.

During driving, detecting the driver's inattentive state indicating the degree of the driver's concentration on driving is especially important for reducing accidents caused by the driver's inattentiveness. The state detection device according to the present disclosure enables accurately detecting the driver's inattentive state,

Moreover, a state detection method according to an aspect of the present disclosure is a state detection method of detecting a state of a driver driving an automobile, and includes: capturing, by a first camera, a face of the driver at a first frame rate; capturing, by a second camera, an environment in a forward direction of the automobile at a second frame rate; calculating a line-of-sight direction of both eyes of the driver based on a face image obtained from the first camera; calculating a focal position of the driver based on the line-of-sight direction of the both eyes of the driver calculated; and detecting the state of the driver by determining the state of the driver based on the focal position calculated and a. forward image obtained from the second camera, wherein. the first frame rate is N times the second frame rate.

As above, the driver's state can be detected. without using any parameter that depends on an external environment, such as the pupil diameter. The state detection method according to the present disclosure thus enables accurately detecting the driver's state. Because the first frame rate is N times the second frame rate, the face image associated with the forward image can be selected in a simple manner. This reduces the amount of processing.

Furthermore, an aspect of the present disclosure can be implemented as a program for causing a computer to perform the state detection method described above, or as a computer-readable recording medium having the program recorded thereon.

The following describes an embodiment with reference to the drawings.

Note that the following embodiment illustrates a general or specific example. The numerical values, shapes, materials, elements, the arrangement and connection of the elements, steps, the processing order of the steps etc. illustrated in the following embodiment are mere examples, and are not intended to limit the present disclosure.

Note that the figures are represented schematically and are not necessarily precise illustrations. Therefore, for example, the scales and the like in the figures are not necessarily precise. In the figures, the same reference signs are given to essentially the same elements, and redundant descriptions are omitted or simplified.

The following description may include expressions such as “greater than or equal to a predetermined angle” and “less than a predetermined angle.” Such expressions, however, are not used in their strict senses. For example, a pair of expressions “greater than or equal to a predetermined angle” and “less than the predetermined angle” simply indicate separation by the predetermined angle and may also mean “greater than the predetermined angle” and “less than or equal to the predetermined angle,” respectively

### Embodiment

### [Configuration]

First, a configuration. of a state detection device according to an embodiment will be described.

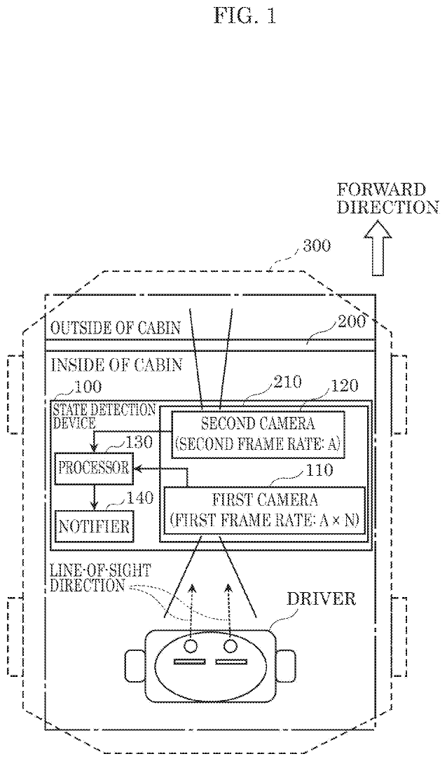

FIG. 1 is a block diagram illustrating state detection device 100 according to an embodiment,

State detection device 100 detects (measures) the state of a driver driving automobile 300. For example, state detection device 100 detects, as the driver's state, the driver's inattentive state or the degree of the driver's sleepiness. In this embodiment, state detection device 100 detects the driver's inattentive state. Specifically state detection device 100 detects whether the driver is in an inattentive state in which the driver cannot concentrate on driving.

State detection device 100 includes first camera 110, second camera 120, processor 130, and notifier 140.

First camera 110 captures, at a first frame rate, the face of the driver driving automobile 300. For example, first camera 110 is communicatively connected with processor 130 and, in response to receiving a signal from processor 130 instructing to start capturing, captures the driver's face to generate a face image including the driver's face. For example, first camera 110 repeatedly captures the driver's face at a predetermined frame rate (the first frame rate) to repeatedly generate the face image and send the face image to processor 130.

First camera 110 is, for example, a digital camera having an image sensor, such as a charge coupled device (CCD) image sensor or a complementary metal oxide semiconductor (CMOS) image sensor.

Second camera 120 captures the environment in the forward direction (the direction in which automobile 300 is traveling) of automobile 300 at a second frame rate. The environment in the forward direction of the automobile means the area ahead of moving automobile 300. For example, second camera 120 is communicatively connected with processor 130 and, in response to receiving a signal from processor 130 instructing to start capturing, captures the environment in the forward direction of automobile 300 to generate a forward image including the view ahead of automobile 300. For example, second camera 120 repeatedly captures the environment in the forward direction of automobile 300 at a predetermined frame rate (the second frame rate) to repeatedly generate the forward image and send the forward image to processor 130.

The first frame rate is N times the second frame rate (N is an integer greater than or equal to one). That is, the frame rate of first camera 110 is N times the frame rate of second camera 120 (N is an integer greater than or equal to one). For example, if the second frame rate is A (A is an arbitrary positive number), the first frame rate is A×N. As a specific example, for the first frame rate of 60 fps, the second frame rate may be 30 fps.

First camera 110 may be placed at any position from which the driver's face can be captured. Second camera. 120 may be placed at any position from which. the environment in the forward direction of automobile 300 can be captured. For example, first camera 110 and second camera 120 are affixed to automobile 300 as an integral unit. “Affixed as an integral unit” means that the cameras are affixed to automobile 300 while their relative positional relationship (the relationship in their capturing directions) is fixed. For example, first camera 110 and second camera 120 are affixed to automobile 300 while being fixedly placed in same housing 210. Housing 210 is a box, for example, and in this embodiment, first camera 110 and second camera 120 are put in housing 210 and placed in the cabin of automobile 300. Second camera 120 captures the environment in the forward direction of automobile 300 from inside the cabin of automobile 300 through windshield 200 (the glass window at the front of automobile 300), for example.

Second camera 120 is, for example, a digital camera having an image sensor, such as a CCD image sensor or a CMOS image sensor. More specifically second camera 120 is a. time-of-flight (TOO camera. The forward image generated by second camera 120 therefore includes distance information. This allows processor 130 to, for example, calculate the distance between automobile 300 (more specifically, second camera 120) and an object in the forward image generated by second camera 120.

Second camera 120 may be any camera (sensor) that enables calculating the distance to the object in the forward image, and may be a TOF camera or may be a camera capable of multi-directional capturing, such as a. stereo camera. Second camera 120 may also be a monocular camera.

Processor 130 is a device that processes images obtained from first camera 110 and second camera 120. Specifically, processor 130 calculates the line-of-sight directions of the driver's eyes from the face image obtained from first camera 110 (specifically calculates the line-of-sight direction of each of the left and right eyes) and calculates the driver's focal position from the line-of-sight directions of the driver's eyes calculated. Processor 130 then detects the driver's state by determining the driver's state from the focal position calculated and the forward image obtained from second camera 120.

The line-of-sight direction is the direction in which the driver looks. As a specific example, the line-of-sight direction is represented by arrows in FIG. 1. For example, processor 130 processes the face image to extract an iris area and calculates the driver's line-of-sight direction based on the shape and the center position of the iris extracted.

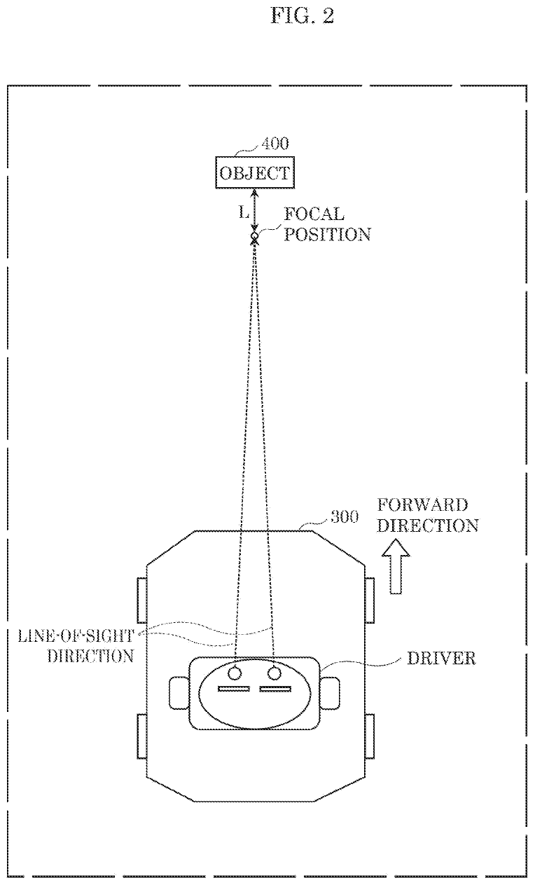

FIG. 2 is a diagram for describing the driver's focal position.

Processor 130 calculates, from the driver's line-of-sight directions, where the driver's focal position is, Processor 130 further identifies, in the forward image generated by second camera 120, object 400 located in the driver's line-of-sight direction. Processor 130 calculates a deviation amount (distance L) indicating how far the focal position deviates from object 400 identified, and detects the driver's state according to the deviation amount calculated.

First, for example, processor 130 calculates the line-of-sight direction of the right eye and the line-of-sight direction of the left eye based on the face image. From the line-of-sight directions of the right and left eyes calculated, processor 130 then calculates, as the focal position, the intersection of a virtual straight. Line along the line-of-sight direction of the right eye and a virtual straight line along the line-of-sight direction of the left eye. The focal position here is represented as, for example, the distance to automobile 300 or the driver. Alternatively, the focal position here may be represented as a position in any predetermined coordinate system.

Processor 130 then calculates, from the forward image, the position of object 400 included in the forward image and located in the driver's line-of-sight direction. Specifically, for example, processor 130 calculates a position of object 400 located in the line-of-sight direction and in the vicinity of automobile 300, based on the line-of-sight direction and the forward image, and determines the state of the driver based on the position of object 400 and the focal position calculated. For example, processor 130 selects a face image associated with a forward image. For example, processor 130 associates (in other words, links) a forward image and a face image, generated by first camera. 110 and second camera 120 by capturing with the same timing (at the same time), with each other. Processor 130 then. calculates the driver's focal position. and line-of-sight direction from the face image, and calculates, from the forward image associated with the face image, the position of object 400 included in the forward image and located in the line-of-sight direction calculated. Processor 130 detects the driver's state (more specifically, the driver's inattentive state) by determining the driver's state based on the position of object 400 and the focal position calculated.

The position of object 400 here is represented as, for example, the distance to the object that also serves as the reference object for the focal position (automobile 300 or the driver). Alternatively, the position of object 400 here may be represented as a position in any predetermined coordinate system, as with the focal position.

The driver's line-of-sight direction here is, for example, the direction in the middle of the line-of-sight directions of the right and left eyes.

Processor 130 then calculates distance L between the focal position and the position of object 400 calculated. If, for example, the calculated distance L between the position of object 400 and the focal position is less than a predetermined distance, processor 130 determines that the driver is in a normal state. By contrast, if, for example, the calculated distance L between the position of object 400 and the focal position is greater than or equal to the predetermined distance, processor 130 determines that the driver is not in a. normal state. For example, for distance L less than 50 cm, processor 130 determines that the driver is driving normally (the driver is in a normal state). For distance L greater than or equal to 50 cm and less than 100 cm, processor 130 determines that the driver is in an inattentive state (the driver is not in a normal state). For distance L greater than or equal to 100 cm, processor 130 determines that the driver is in an unsafe state such as epilepsy (the driver is not in a normal state).

In this manner, processor 130 can stably detect the state of the driver driving automobile 300 irrespective of the brightness around the driver.

The predetermined distance may be any predetermined distance and is not limited to a particular value.

As described above, processor 130 may determine that the driver is in an inattentive state if, for example, distance L from the focal position to object 400 is greater than or equal to 50 cm and less than 100 cm.. Alternatively, processor 130 may determine the degree of the driver's inattentiveness as a percentage. That is, processor 130 may determine the driver's state as a percentage. If, for example, the focal position deviates by 1 m from the position of object 400 (i.e., if distance L is 1 m), processor 130 may determine that the driver is 100% in an inattentive state. If, for example, the focal position deviates by 50 cm from the position of object 400 (i.e., if distance L is 50 cm), processor 130) may determine that the driver is 50% in an inattentive state.

Each distance and its corresponding percentage illustrated above are merely exemplary and may be any predetermined distance and percentage without being limited to particular values.

Processor 130 thus detects the driver's state based on the face image and the forward image.

If the driver's face orientation or hue-of-sight direction deviates from the forward direction for a certain time period or gradually deviates from. the forward direction, processor 130 may determine that, for example, the driver is in an unsafe state, such as epilepsy from the face orientation or line-of-sight direction and from the certain time period or the time taken by the deviation.

The face orientation is the direction in which the driver faces. Specifically the face orientation is represented as the front direction of the driver's face. For example, processor 130 measures the driver's face orientation by subjecting the face image to face detection processing to extract feature points on the driver's eyes and mouth.. The description of this embodiment assumes that the driver's face orientation is the same as the line-of-sight direction of the driver's both eyes.

For example, processor 130 determines that the state of the driver is not normal when an angle between the line-of-sight direction and the forward direction is greater than or equal to a predetermined angle. For example, if the driver sees outside the range of ±20 degrees with respect to the forward direction (i.e., the predetermined angle is 20 degrees) for 3 seconds, or if the driver's face orientation continuously changes at a speed of less than or equal to 10 degrees every 0.1 second, processor 130 determines that the driver is in an unsafe state such as epilepsy.

In this manner, processor 130 can easily detect the driver's health condition. if state detection device 100 is to detect only the driver's health condition as above, state detection device 100 need not include second camera 120.

The predetermined angle may be any predetermined angle and. is not limited to a particular value.

In the above, processor 130 detects the driver's state based on the angle between the forward direction and the line-of-sight direction, Alternatively, processor 130 may use the face orientation (the facing direction) calculated from the face image and detect the driver's state based on an object located in the facing direction in the forward image. For example, if a billboard or a sign is located in the calculated facing direction and the driver is facing in. that direction for a short time period, processor 130 may determine that the driver is concentrating on driving. In another example, if the driver is facing in the calculated facing direction for a long time period, and the object located in the facing direction is such an object that remains in the view irrespective of the traveling of automobile 300, such as the road or the sky, processor 130 may determine that the driver is in an inattentive state.

Processor 130 sends information indicating the detection result (the result of the determination of the driver's state) to notifier 140.

Processor 130 is implemented as a computer device, for example. Specifically, processor 130 is implemented by components such as nonvolatile memory storing a program, volatile memory serving as a temporary storage area for executing the program, an input/output port, and a processor executing the program. The functions of processor 130 may be carried out in processor-executed software, or in hardware such as electric circuitry that includes one or more electronic components.

Notifier 140 is a device that provides a notification of the information indicating the detection result (the result of the determination of the driver's state) received from processor 130. Notifier 140 is, for example, a display that notifies the driver of the information indicating the detection result as an image, or a sound device that notifies the driver of the information as sound, Notifier 140 may be implemented as a personal computer, a smartphone, or a tablet terminal.

[Process steps]

Now, process steps performed by state detection device 100 according to the embodiment will be described in detail.

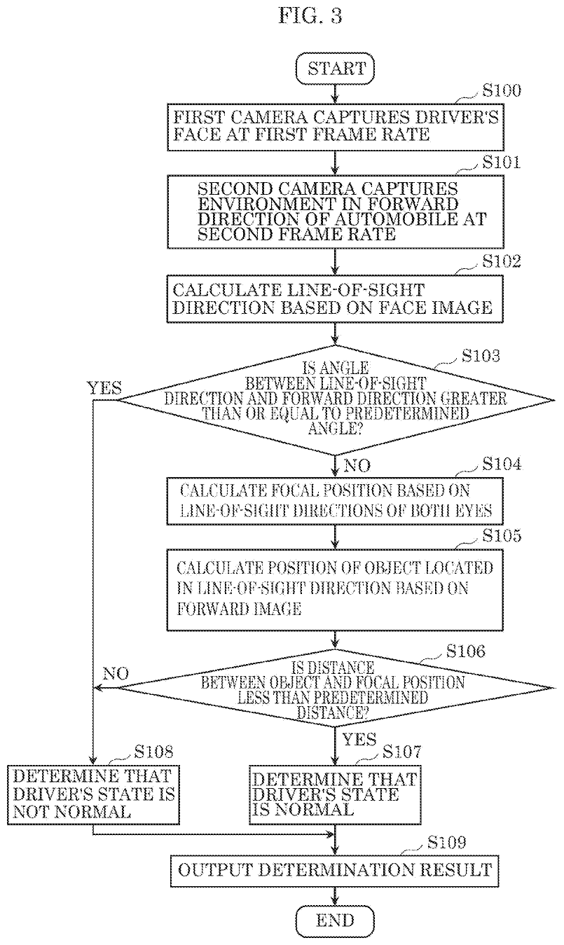

FIG. 3 is a flowchart showing the process steps performed by the state detection device according to the embodiment.

First, state detection device 100 causes first camera 110 to capture the driver's face at the first frame rate (a frame rate N times the first frame rate) (step S100).

State detection device 100 then causes second camera 120 to capture the environment in the forward direction of automobile 300 at the second frame rate (step S101).

Thus, at steps S100 and S101, state detection device 100 (more specifically; processor 180) causes first camera 110 and second camera 120 to capture the driver's face and the environment in the forward direction of automobile 300, thereby obtaining a face image including the driver's face, and a forward image showing the environment in the forward direction of automobile 300.

More specifically first at. step S100, first camera 110 repeatedly generates the face image by capturing the driver's face at the first frame rate. Processor 130 repeatedly obtains the face image from first camera 110.

At step S101, second camera 120 repeatedly generates the forward image by capturing the environment in the forward direction of automobile 300 at, the second frame rate. Processor 1.30 repeatedly obtains the forward image from second camera 120, For example, processor 130 sends a signal instructing first camera 110 and second camera 120 to start capturing. In response to the signal, first camera 110 and second camera 120 start capturing at the above frame rates. In this manner, processor 130 can cause first camera 110 and second camera 120 to start capturing with the same timing, that is, can synchronize the capturing timing of first camera 110 and second camera 120.

This facilitates associating (linking) the face image and the forward image, generated by capturing at the same time, with each other.

Based on the face image obtained at. step S100, processor 130 then calculates the driver's line-of-sight direction (step S102).

Processor 130 then determines whether the angle between the :line-of-sight direction calculated at step S102 and the forward direction is greater than or equal to a predetermined angle (step S103). The forward direction means the direction in which automobile 300 is traveling, which is, for example, the capturing direction of second camera 120.

If processor 130 determines that the angle between the line-of-sight direction and the forward direction is greater than or equal to the predetermined angle (Yes at step S103), processor 130 determines that the driver is not in a. normal state (step S108).

Processor 130 then causes notifier 140 to notify the driver of information indicating the result of the determination made at step S108 (step S109).

If processor 130 determines that the angle between the line-of-sight direction and the forward direction is less than the predetermined angle (No at step S103), processor 130 calculates the focal position based on the line-of-sight directions of the driver's both eyes (step S104).

Based on the forward image obtained at step S101, processor 130 then calculates the position of object 400 located in the line-of-sight direction (step S105).

Processor 130 then determines whether distance L between the position of object 400 calculated at step 5105 and the focal position calculated at step S104 is less than a predetermined distance (step S106).

If processor 130 determines that distance L is less than the predetermined distance (Yes at step 5106), processor 130 determines that the driver is in a normal state (step S107).

Processor 130 then causes notifier 140 to notify the driver of the result of the determination made at step S107 (step S109).

If processor 130 determines that distance L is greater than or equal to the predetermined distance (No at step S106), processor 130 determines that the driver is not in a normal state (step S108), and performs step S109.

### Advantageous Effects, Etc.

As described above, state detection device 100 is a state detection device that detects a state of a driver driving automobile 300, and includes: first camera 110 that captures a face of the driver at a first frame rate; second. camera 120 that captures an environment in a forward. direction. of automobile 300 at a second frame rate; and processor 130 that: calculates a line-of-sight direction of both eyes of the driver based on a face image obtained from first camera 110, and calculates a focal position of the driver based on the line-of-sight direction of the both eyes of the driver calculated; and detects the state of the driver by determining the state of the driver based on the focal position calculated and a forward image obtained from second camera 120. Here, the first frame rate is N times the second frame rate.

As above, processor 130 can detect the driver's state without using any parameter that depends on an external environment, such as the pupil diameter. State detection device 100 thus enables accurately detecting the driver's state. Because the first frame rate is N times the second frame rate, processor 130 can, for example, select the face image associated with the forward image in a simple manner. This reduces the processing load on processor 130, In addition, because more face images are generated than forward images processor 130 can, for example, frequently determine the driver's state by frequently calculating the driver's line-of-sight direction from the face images and determining whether the driver is in a normal state from the line-of-sight direction calculated.

Moreover, for example, first camera 110 and second camera 120 are affixed to automobile 300 as an integral unit.

For example, first camera 110 and second. camera 120 are placed in same housing 210. If first camera 110 and second camera 120 were individually affixed to automobile 300, the forward image captured by second. camera 120 would. misalign with the line-of-sight direction calculated from the image from first camera 110, resulting in an error requiring calibration by processor 130 according to the positions of the cameras. Affixing first camera 110 and second camera 120 to automobile 300 as an integral unit advantageously eliminates the need for such calibration and maintains high accuracy of detection. That is, this prevents changes in the relative positional relationship between first camera 110 and second camera 120. The driver's state can thus be detected more accurately.

Moreover, for example, second camera 120 is a time-of-flight (TOF) camera.

This enables accurately measuring how far the focal position of the driver's line of sight deviates from, for example, object 400 located in the line-of-sight direction. The driver's state can. thus be detected more accurately.

Moreover, for example, processor 130: calculates a position of object 400 located in the line-of-sight direction and in a vicinity of automobile 300, based on the line-of-sight direction and the forward image; and determines the state of the driver based on the position of object 400 and the focal position calculated.

Moreover, for example, processor 130: determines that the state of the driver is normal when distance L between the position of object 400 and the focal position calculated is less than a predetermined distance; and determines that the state of the driver is not normal when distance L is greater than or equal to the predetermined distance.

As above, whether the driver is in a normal state can be accurately detected based on the distance between the position of object 400 and the focal position.

Moreover, for example, processor 130 determines that the state of the driver is not normal when an angle between the line-of-sight direction and the forward direction is greater than or equal to a predetermined angle.

If, for example, the driver's line-of-sight direction significantly deviates from the forward direction, this suggests that the driver is not driving normally and consequently that the driver is not in a. normal state. As such, processor 130 can appropriately determine that the driver is not in a normal state if the angle between the driver's line-of-sight direction and. the forward direction is greater than or equal to the predetermined angle.

Moreover, for example, the state of the driver is an inattentive state of the driver.

During driving, detecting the driver's inattentive state indicating the degree of the driver's concentration on driving is especially important for reducing accidents caused by the driver's inattentiveness. State detection device 100 according to the present disclosure enables accurately detecting the driver's inattentive state.

Moreover, a state detection method. according to an aspect of the present disclosure is a state detection method. of detecting a state of a driver driving automobile 300, and includes: capturing, by first camera 110, a face of the driver at a first frame rate; capturing, by second camera 120, an environment in a forward direction of automobile 300 at a second frame rate; calculating a line-of-sight direction of both eyes of the driver based on a face image obtained from first camera 110; calculating a focal position of the driver based on the line-of-sight direction of the both eyes of the driver calculated; and detecting the state of the driver by determining the state of the driver based on the focal position calculated and a forward image obtained from second camera 120. Here, the first frame rate is N times the second frame rate.

As above, the driver's state can be detected without using any parameter that depends on an external environment, such as the pupil diameter. The state detection method according to the present disclosure thus enables accurately detecting the driver's state. Because the first frame rate is N times the second frame rate, the face image associated with the forward image can be selected in. a simple manner. This reduces the amount of processing. In addition, because more face images are generated than forward images, processor 130 can, for example, frequently determine the driver's state by frequently calculating the driver's line-of-sight direction from the face images and determining whether the driver is in a normal state from the line-of-sight direction calculated.

Furthermore, an aspect of the present disclosure can be implemented as a program for causing a computer to perform the state detection method. described above, or as a computer-readable recording medium having the program. recorded. thereon.

### Other Embodiments

Although the state detection device and the like according to one or more aspects have been described based on an embodiment, the present disclosure is not limited to the embodiment. Embodiments achieved by making various modifications that may be conceived by those skilled in the art to the present embodiment, as well as embodiments resulting from combinations of elements from different embodiments are intended to be included within the scope of the present disclosure, so long as they do not depart from the purport of the present disclosure.

For example, based on the face image, processor 130 may determine the driver's state from how the driver's mouth is open. If, for example, the driver's mouth is open 1 cm or wider for 2 or more seconds, processor 130 determines that the driver is in an inattentive state.

In this manner, processor 130 can extremely easily determine the driver's state. In this case, state detection device 100 need not include second camera 120.

If, for example, the driver's mouth is open 2 cm or wider for 5 or more seconds, processor 130 may determine that the driver is in epilepsy rather than in an inattentive state.

In this manner, state detection device 100 can determine the driver's unsafe state, such as epilepsy, in an extremely simple way,

The state detection device may also include, for example, a microphone that detects the driver's voice. In this case, processor 130 may determine the driver's state based on the face image and the driver's voice detected by the microphone. For example, if processor 130 determines that the driver is not speaking based on the driver's voice detected by the microphone, and determines that the driver's mouth is not open or is repeatedly opened and closed based on the face image, processor 130 may determine that the driver is in an unsafe state such as epilepsy.

The above degrees and time periods of the driver's mouth opening referred to by processor 130 for making a determination are merely exemplary and may be set to any value without being limited to a particular value.

Processor 130 may calculate the driver's heart rate((cardiac rate) based on the face image and detect the driver's state based on the heart rate calculated. For example, processor 130 may determine the driver's heart rate based on the complexion of the driver in the face image.

For example, the heart rate typically increases when the emotion of anger arises. If the driver's heart rate increases although no emotion of anger arises in the driver, the driver can be in an unsafe state such as epilepsy, As such, processor 130 may determine the driver's facial expression and heart rate based on the face image is processor 130 determines that the heart rate increases although the driver does not have an angry expression, processor 130 may determine that the driver is in an unsafe state such as epilepsy.

It is to be understood that the driver's heart, rate may be calculated. from a basis other than the face image. For example, state detection device 100 may include a millimeter wave sensor for detecting the heart rate by millimeter waves, or a contact heart-rate sensor attached to the steering wheel of automobile 300. Processor 130 may calculate the driver's heart rate based on information obtained from these sensors.

As another example, processor 130 may calculate, based on the forward image, the position of automobile 300 in the right-left direction with respect to the lane of the road in which automobile 300 is traveling. If, for example, the position of automobile 300 in the right-left direction monotonously changes for a. predetermined time period, processor 130 may determine that the driver is in an inattentive state. A driver in an inattentive state, typically does not operate the steering wheel in a bit-by-bit manner. As such, if, for example, the position of automobile 300 in the right-left, direction monotonously changes to the left or right for about 2 seconds, processor 130 can determine that the driver is in an inattentive state.

If, for example the position of automobile 300 monotonously changes to the left or right with no steering operations for 3 or more seconds, processor 130 may determine that the driver is in epilepsy.

In this manner, state detection device 100 can determine the driver's abnormal state, such as epilepsy; in an extremely simple way.

As another example, processor 130 may determine the driver's state based on the acceleration. of automobile 300,

As another example, processor 130 may determine the driver's state based on the speed of automobile 300 or how the driver presses the accelerator pedal.

Typically, a driver normally driving automobile 300 at a speed of 30 km/h or higher on an ordinary road switches the accelerator pedal on or off about once every 5 seconds. As such, for example, if the driver presses the accelerator pedal and holds it for 5 or more seconds, or if the driver never presses the accelerator pedal for 5 or more seconds although no other vehicles are ahead of automobile 300, processor 130 determines that the driver is in an unsafe state such as epilepsy. Further, if, for example, the driver never presses the accelerator pedal for 3 or more seconds although no other vehicles are ahead of automobile 300, processor 130 determines that the driver is in an inattentive state.

As another example, processor 130 may determine the driver's state based on the steering angle of the steering wheel of automobile 300. in this case, state detection device 100 further includes, for example, an angle sensor for detecting the steering angle of the steering wheel. If, for example, the steering wheel is never turned in one direction and then the other for 3 or more seconds, processor 130 determines that the driver is in an inattentive state. if, for example, the steering wheel is never turned in one direction and then the other for 5 or more seconds, processor 130 determines that the driver's sleepiness has increased. If, for example, the steering wheel is never turned in one direction and. then the other for 10 or more seconds, processor 130 determines that the driver is in an unsafe state such as epilepsy.

As another example, processor 130 may detect the driver's state based on the driver's brain waves. In this case, state detection device 100 further includes, for example, a brain wave sensor for detecting the driver's brain waves.

If, for example, low-frequency components such as alpha waves and theta waves in the driver's brain waves are dominant over high-frequency components, the driver is considered to be in an inattentive state. If, for example, theta waves in the driver's brain waves are dominant over other frequency components, the driver's sleepiness is considered to have increased. If high-frequency components (amplitudes) of 30 Hz or higher in the driver's brain waves increase, the driver is considered to be in an unsafe state such as epilepsy As such, for example, processor 130 determines, based on the driver's brain waves, the driver's state (e.g., whether the driver is in a normal state, in an inattentive state, sleepy, or in an unsafe state).

In this manner, processor 130 can determine the driver's state simply from the driver's brain waves.

As another example, processor 130 may determine the driver's state based on the driver's driving posture. In this case, state detection device 100 may further include, for example, a camera (a. third camera) for generating a cabin image by capturing the inside of the cabin of automobile 300, including the driver. Alternatively first camera 110 may generate a cabin image by capturing the driver's upper body, rather than only the driver's face. Processor 130 calculates, for example, the driver's driving posture based on the cabin image.

If, for example, the driver abruptly changes the driving posture, such as suddenly putting the driver's head down on the steering wheel, processor 130 determines that the driver is in an unsafe state such as epilepsy

Processor 130 may calculate the driver's driving posture in any manner.

For example, state detection device 100 may further include a seat sensor placed on the driver's seat. In this case, for example, processor 130 may receive information indicating the centroid position of the driver on the seat from the seat sensor. If for example, the information received indicates a. sudden change in the centroid position of the driver on the seat, processor 130 may determine that, the driver is in an unsafe state such as epilepsy.

The above description has illustrated states such as an. inattentive state, a state indicating the degree of sleepiness, and epilepsy as the driver's state detected by processor 130. However, other states may be detected.

For example, as the driver's state, processor 130 may detect the degree of the driver's fatigue, the degree of the driver's concentration, or the driver's various emotions.

As another example, processor 130 may detect an unsafe state, for example myocardial infarction or cerebral infarction, as the driver's state. Any condition for processor 130 to determine the driver's state may be appropriately preset for such a state to be detected.

The above-illustrated conditions for processor 130 to determine the driver's state are merely exemplary. Any condition may be appropriately set according to, for example, the level required by the user of state detection device 100.

When the driver's state is fed back (as a notification) to the driver (e.g., when notifier 140 notifies the driver of the result of the determination made by processor 130), the notification is more likely to surprise the driver as the driver is in a more serious state, such as epilepsy or myocardial infarction. Surprising the driver can disturb the driver's driving operations. To prevent this, notifier 140 may provide, for example, a notification of the level of the driver's state, such as “the physical condition deterioration level,” rather than a notification of a disease name or the like. For example, processor 130 determines the level of the driver's state on a scale of 1 to 5 in order from the best state. Notifier 140, for example, notify the driver of the level determined by processor 130.

Automobile 300 may be a self-driving vehicle capable of driving at multiple self-driving levels. In this case, for example, processor 130 may transfer a larger percentage of driving authority from the driver to automobile 300 as the level of the driver's state is determined to be lower.

For example, at self-driving level 0, the driver performs all driving operations. For example, at self-driving level 1 the self-driving vehicle supports either steering operations or acceleration and deceleration.. For example, at self-driving level 2, the self-driving vehicle supports either steering operations or acceleration and deceleration. For example, at self-driving level 3, the self-driving vehicle performs all driving operations in specific places whereas the driver performs driving operations in case of emergency. For example, at self-driving level 4, the self-driving vehicle performs all driving operations in specific places. For example, at self-driving level 5, the self-driving vehicle performs all driving operations.

If, for example, the driver's state is level 3, processor 130 causes the self-driving vehicle to operate at self-driving level 3.

In this manner, the driver can be safely notified of the driver's state.

As another example, some of the process steps performed by processor 130 may be performed in different orders or in parallel.

As another example, the processing described in. the above embodiment may be implemented by centralized processing using a single device (system) or by distributed processing using multiple devices. The above processor executing the program may be a single processor or may include multiple processors. That is, the processor may perform centralized processing or distributed processing.

Moreover, all or part of the elements of processor 130 in the above embodiment may be configured in the form of an exclusive hardware product, or may be implemented by executing a software program suitable for the element. Each element may be implemented by means of a program executer, such as a central processing unit (CPU) or a processor, reading and executing a software program recorded on a recording medium such as a hard disk drive (HDD) or a semiconductor memory.

Moreover, processor 130 may be configured with one or more electric circuits. The one or more electric circuits may each be a general purpose circuit, or may be a dedicated circuit.

The one or more electric circuits may include, for example, a semiconductor device, an integrated circuit (IC), a large scale integration (LSI) circuit, or the like. The IC or LSI may be integrated into one chip, or may be integrated into a plurality of chips. It is referred to as IC or LSI here, but may be referred to as a system LSI circuit, a very large scale integration (VLSI) circuit, or an ultra large scale integration (ULSI) circuit, depending on the degree of integration. A field-programmable gate array (FPGA) which is programmed after an LSI circuit is fabricated can be used for the same purpose.

A general or specific aspect of the present disclosure may be implemented using a system, a device, a method, an integrated circuit, or a computer program. Alternatively, it may be implemented using a non-transitory computer-readable recording medium, such as an optical disc, an HDD, or a semiconductor memory, having the computer program recorded thereon, It may also be implemented using any combination of systems, devices, methods, integrated circuits, computer programs, or recording media.

In addition, various modifications, replacements, additions, omissions, or the like can be made to each embodiment described above within the scope of the claims or in a scope equivalent; to the scope of the claims.

### INDUSTRIAL APPLICABILITY

The present disclosure can be used as a state detection device that enables accurately detecting a driver's state, and can be used as, for example, a device that detects a driver's inattentive state during driving.

### REFERENCE MARKS IN THE DRAWINGS

100 state detection device
110 first camera
120 second camera
130 processor
140 notifier
200 windshield
210 housing
300 automobile
400 object
L distance

1. A state detection device that detects a state of a driver driving an automobile, the state detection device comprising:
a first camera. that captures a. face of the driver at a first frame rate;
a second camera that captures an environment in a forward direction of the automobile at a second frame rate; and
a processor that:
calculates a line-of-sight direction of both eyes of the driver based on a face image obtained from the first camera, and calculates a focal position of the driver based on the line-of-sight direction of the both. eyes of the driver calculated; and
detects the state of the driver by determining the. state of the driver based on the focal position calculated and a forward image obtained from the second camera,
wherein the first frame rate is N times the second frame rate, where N is an integer greater than or equal to 1.

2. The state detection device according to claim 1,
wherein the first camera and the second camera are affixed to the automobile as an integral unit.

3. The state detection device according to claim 1 or 2,
wherein the second camera. is a time-of-flight (TOF) camera.

4. The state detection device according to any one of claims 1 to 3,
wherein the processor:
calculates a position of an object located in the line-of-sight direction and in a vicinity of the automobile, based on the line-of-sight direction and the forward image; and
determines the state of the driver based on the position of the object and the focal position calculated.

5. The state detection device according to claim 4,
wherein the processor:
determines that the state of the driver is normal when a distance between the position of the object and the focal position calculated is less than a predetermined distance; and
determines that the state of the driver is not normal when the distance is greater than or equal to the predetermined distance.

6. The state detection device according to any one of claims 1 to 5,
wherein the processor determines that the state of the driver is not normal when an angle between the line-of-sight direction and the forward direction is greater than or equal to a predetermined angle.

7. The state detection device according to any one of claims 1 to 6,
wherein the state of the driver is an inattentive state of the driver.

8. A state detection method of detecting a state of a driver driving an automobile, the state detection method comprising:
capturing, by a first camera, a face of the driver at a first frame rate;
capturing, by a second camera, an. environment in a forward direction of the automobile at a second frame rate;
calculating a line-of-sight direction of both eyes of the driver based on a face image obtained from the first camera;
calculating a focal position of the driver based on the line-of-sight direction of the both eyes of the driver calculated; and
detecting the state of the driver by determining the state of the driver based on the focal position calculated and a forward image obtained from the second camera,
wherein the first frame rate is N times the second frame rate.
